(19) United States
(12) Patent Application Publication
(10) Pub. No.: US 2011/0019224 A1
(43) Pub. Date: Jan. 27, 2011

(54) METHOD AND SYSTEM FOR RE-ORDERING AT LEAST ONE IMAGE OF A SCANNED MULTI-PAGE DOCUMENT

(75) Inventor: Paul R. Austin, Webster, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/509,672

(22) Filed: Jul. 27, 2009

(51) Int. Cl. G06F 15/00

(52) U.S. Cl. 358/1.15

(57) ABSTRACT

A multi-function machine having capabilities of at least scanning documents is presented. The multi-function machine includes a scanning assembly for generating a plurality of electronic images and a re-ordering subsystem, operatively associated with the multi-function machine, for performing an ordering determination procedure with respect to the plurality of electronic images. The ordering determination procedure further includes (1) analyzing the plurality of electronic images to determine whether the plurality of images are in a pre-selected order, and (2) responsive to determining that the plurality of electronic images are not in the pre-selected order, electronically re-ordering at least one of the plurality of electronic images to conform with the pre-selected order.

### BACKGROUND

1. Field of the Related Art

The present disclosure relates to multi-function machines, and more particularly, to a multi-function machine having the capability of re-ordering at least one image of a plurality of images of a scanned multi-page document.

2. Background of the Related Art

“Multi-function” machines have become familiar in offices and in home computing environments. Whereas, previously, functions such as copying, printing, and facsimile transmission have been performed by single dedicated copiers, printers, and facsimiles respectively, a multi-function machine is typically capable of providing all such functions and more in a single machine. Typically, such a multi-function machine includes a single print engine, which can serve to output copies, prints, or received facsimiles; as well as a single input scanner which can serve to record data from original images for use in copying, facsimile transmission, and retention of input image data to a predetermined location in a computer memory (“scan-to-file”) in the multi-function machine or in another device.

Such multi-function machines are typically connected to data networks, such as a local area network or the Internet, for exchange of both image data and associated operational instructions. Their connection to data networks also enables an operator to scan a document to create an electronic image file and store the electronic image file on a networked device, such as a file server. The multi-function machine can be a xerographic machine which uses xerographic printing techniques to print a reproduction of a document placed on a platen glass or on an automated document feeder.

While scanning a stack of pages or using an automated document feeder, unbound stacks of paper can easily lose page sequence. For example, when the stack of paper has been dropped, the paper scattered on the floor and then scooped back together by the user, it may not be placed in the proper order. It is also common for scans or copies of duplex paper stacks to be out of order due to a jam of a sheet feeder. The process of manually reassembling a numbered stack of pages, orienting them correctly, and placing them in page number sequence is time consuming and error-prone.

Existing office equipment is not capable of re-ordering and re-orienting an entire set of scanned pages correctly, placing them in page number sequence, and reprinting the resulting document. Further, such equipment is incapable of alerting the operator of missing pages. Accordingly, there is a need for a better means of scanning the entire set of pages, correctly orienting the set, placing the set in page number sequence, alerting the user of missing pages, and reprinting the resulting documents.

### SUMMARY

In an aspect of the present disclosure, a multi-function machine having capabilities of scanning and printing documents is provided, including a scanning assembly for generating a plurality of electronic images and a re-ordering subsystem, operatively associated with the multi-function machine, for performing an ordering determination procedure with respect to the plurality of electronic images. The ordering determination procedure includes (1) analyzing the plurality of electronic images to determine whether the plurality of images are in a pre-selected order, and (2) responsive to determining that the plurality of electronic images are not in the pre-selected order, electronically re-ordering at least one of the plurality of electronic images to conform with the pre-selected order.

In another aspect of the present disclosure, a method is provided for re-ordering a multi-page document, including generating the multi-page document with a scanning system and using a processor for analyzing the multi-page document to determine whether the pages of the multi-page document conform with a pre-selected order, and responsive to determining that the multi-page document fails to conform with the pre-selected order, re-ordering one or more pages of the multi-page document so that the multi-page document conforms with the pre-selected order and storing said re-ordered multi-page document in memory.

In another aspect of the present disclosure, a system is provided having capabilities of scanning and printing, including a computing device and a computer-readable medium in communication with the computing device, the computer readable storage medium comprising one or more programming instructions for generating the multi-page document with a scanning system and using a processor for analyzing the multi-page document to determine whether the pages of the multi-page document conform with a pre-selected order, and responsive to determining that the multi-page document fails to conform with the pre-selected order, re-ordering one or more pages of the multi-page document so that the multi-page document conforms with the pre-selected order and storing said re-ordered multi-page document in memory.

The present disclosure also provides a computer-readable medium which stores programmable instructions configured for being executed by at least one processor for performing the methods described herein according to the present disclosure. The computer-readable medium can include flash memory, CD-ROM, a hard drive, etc.

### BRIEF DESCRIPTION OF THE DRAWINGS

Various embodiments of the present disclosure will be described herein below with reference to the figures wherein:

FIG. 1 is a schematic diagram of a system having a multi-function machine for re-ordering at least one image of a plurality of images of a scanned multi-page document, in accordance with the present disclosure;

FIG. 2 is a schematic diagram of a system having a multi-function machine for re-ordering and re-orienting at least one image of a plurality of images of a scanned multi-page document, in accordance with the present disclosure; and

FIG. 3 is a flowchart of a method for re-ordering and re-orienting at least one image of a plurality of images of a scanned multi-page document, in accordance with the present disclosure.

### DETAILED DESCRIPTION

The present disclosure proposes a method where a multi-function device (MFD) is used to reorder an unordered set of pages (e.g., a loose-leaf document that has been dropped). The pages would be scanned into a document processing device, such as a multi-function device (MFD). Through the use of optical character recognition (OCR) techniques, automatic page orientation, and a rule set of knowledge for page numbering, dates, transactional documents, and other information available on page, an analysis would be made to determine the proper order of the scanned pages. The MFD would then print the document in the proper order. Missing or indeterminate pages could be determined and brought to the attention of the user. This includes missing page numbers, as well as missing transactional statements such as when the ordering is done based on statement date.

The present disclosure further proposes eliminating the manual effort of reassembling a numbered stack of pages by scanning the entire set of pages, orienting them correctly, placing them in page number sequence, and reprinting the resulting document. As an added feature, the present disclosure further proposes the use of an interface to bring missing pages to the attention of the operator.

For example, in systems such as XIPS (Xerox Image Processing System), image processing is becoming increasingly sophisticated, capable, and is reasonably fast. Acceptable algorithms have been developed for page deskew, page orientation correction, and OCR, particularly of a specific bounded zone. Through OCR, one can examine a sequence of images and look specifically for an index phrase such as page X, or page X of Y, a date, or simply and appropriately placed number or letter. Once a suitable index is found, it is possible to sort a sequence of page images. The correctly ordered sequence of pages can now be used to print a copy of the document, or to form a scanned file with the pages in the correct order, for example as a PDF document.

By observing the sequence of page numbers, it is possible to deduce when pages are missing, and to alert the operator to this fact. Missing pages could be subsequently scanned or provided by other means. Even in the case where dates are used as the index for the sequence, one may well be able to determine a pattern such as dates based one day or one week or one month apart that would allow an operator to detect missing elements.

More sophisticated sequences could be established by combining dates and page numbers. For example, in sorting a collection of bank statements. Each monthly statement consisted of three pages enumerated page 1 of 3, 2 of 3, and 3 of 3. The desired sequence was to have each statement placed an order of most recent date first, with the pages of the statement in the correct sequence and together.

Furthermore, additional checks could be incorporated for redundant pages, blank pages, and pages of a radically different size or document type that were inadvertently interspersed. All of these can help verify the integrity of the document and produce a document of higher integrity following correction.

Prior to describing the present disclosure in further detail, it will first be helpful to define various terms that will be used throughout the following discussion. For example:

The term “print” is overloaded to mean sending the document to the printer through any one of a multitude of ways. Moreover, the term “printer” can refer to any device that accepts text and graphic output from any type of computing device and transfers the information to any printable medium. A “printer” can refer to any type of xerographic, solid ink, liquid ink, cut sheet or web-based device used to print onto a wide array of printable media. The term “printer” as used herein encompasses any apparatus, such as a digital copier, bookmaking machine, facsimile machine, multi-function machine, etc. which performs a print outputting function for any purpose.

As used herein, “print job” is not limited to a particular electronic format, such a bitmap, but can include any suitable format including PDF, word processor formats, rich text (RTF), etc., as will be appreciated by those skilled in the art.

MFDs or multi-function machines disclosed herein include both those that are “connected” and those that are “unconnected,” where connected and unconnected refer to physical connections. An “unconnected” MFD does not have access to a network (e.g., the Internet). A “connected” MFD is normally connected via an Ethernet card or the like to a network. In the present embodiments, the MFD may be an unconnected MFD that is in operative communication with a wireless device, the wireless device being able to access a network. A connection between the multi-function device and the wireless device is made through a two-way communication channel located on the multi-function device.

The term “MFD” or “multi-function machine” can refer to any machine that connects to either a computing device and/or network and performs one or more of the following functions: print, scan, copy, and/or fax. Digital copiers, fax machines, printers, and scanner combinations are all examples of MFDs. The term “MFD” can further refer to any hardware that combines several functions in one unit. For instance, an MFD can be a standalone printer or any type of standalone machine/device/apparatus/component. For example, an MFD can be one or more personal computers (PCs), a standalone printer, a standalone scanner, a mobile phone, an MP3 player, audio electronics, video electronics, GPS systems, televisions, recording and/or reproducing media (such as CDs, DVDs, camcorders, cameras, etc.) or any other type of consumer or non-consumer analog and/or digital electronics. Such consumer and/or non-consumer electronics can apply in any type of entertainment, communications, home, and/or office capacity. Thus, the term “MFDs” can refer to any type of electronics suitable for use with a circuit board and intended to be used by a plurality of individuals for a variety of purposes.

The term “storage” can refer to data storage. “Data storage” can refer to any article or material (e.g., a hard disk) from which information is capable of being reproduced, with or without the aid of any other article or device. “Data storage” can refer to the holding of data in an electromagnetic form for access by a computer processor. Primary storage is data in random access memory (RAM) and other “built-in” devices. Secondary storage is data on hard disk, tapes, and other external devices. “Data storage” can also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

The term “module” refers to a self-contained component (unit or item or subsystem) that is used in combination with other components and/or a separate and distinct unit of hardware or software that may be used as a component in a system, such as a printing system including a plurality of MFDs. The term “module” may also refer to a self-contained assembly of electronic components and circuitry, such as a stage in a computer that is installed as a unit.

The term “document” is a generic term for any piece of paper including information, the information being text and/or images or a set of information designed and presented as an individual entity.

The term “task” refers to a print, scan, copy, and/or fax job or any type of function that may be performed by an MFD. The term “task” may also refer to an execution path through address space, such as a set of program instructions that are loaded in a data storage means. The term “task” may also refer to a basic unit of programming that an operating system controls and depending on how the operating system defines a task in its design, this unit of programming may be an entire program or each successive invocation of a program.

The term “analyze” may refer to determining the elements or essential features or functions or processes of a plurality of MFDs and/or to subject the plurality of MFDs to computational processing. The term “analyze” may further refer to tracking data and/or collecting data and/or manipulating data and/or examining data and/or updating data on a real-time basis in an automatic manner and/or a selective manner and/or manual manner.

The following is a detailed description of the drawings illustrating the present disclosure. In this description, as well as in the drawings, like referenced numbers represent devices, circuits, or equivalent circuits which perform the same or equivalent functions. While the present disclosure is described in connection with a preferred embodiment thereof, it is understood that it is not intended to limit the disclosure to that embodiment. On the contrary, it is intended to cover all alternatives, modifications, and equivalents as may be included within the spirit and scope of the present disclosure as defined by the appended claims.

Embodiments will be described below while referencing the accompanying figures. The accompanying figures are merely examples and are not intended to limit the scope of the present disclosure.

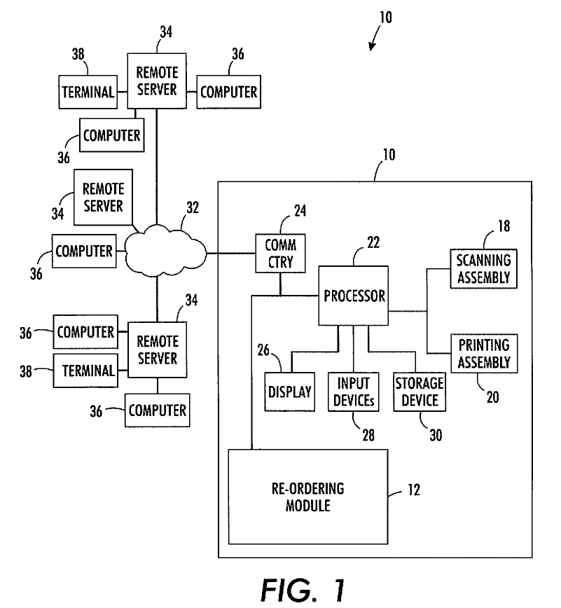

With reference to FIG. 1, there is presented a schematic diagram of a system having a multi-function machine for re-ordering at least one image of a plurality of images of a scanned multi-page document, in accordance with the present disclosure.

The system 1 includes a multi-function machine 10 having a re-ordering subsystem 12, a scanning assembly 18, a printing assembly 20, a processor 22, communication circuitry 24, a display 26, input devices 28 and storage devices 30. The multi-function machine 10 communicates with a communication network 32 that is connected to remote servers 34, computers 36, and terminals 38.

In FIG. 1, one or more documents are scanned by a scanning assembly 18 of the multi-function machine 10 during a document counting and scanning procedure. The documents can be printed by a printing assembly 20, transmitted via communication circuitry 24, and/or stored on storage device 30 of the multi-function machine 10.

The multi-function machine 10 is of the type having the capability of counting and scanning documents. The scanned documents can be printed by the multi-function machine 10, electronically dispatched by email (for example, by SMTP protocol), transmitted to a network device (for example, by FTP, HTTP, NFS, or SMB protocols), and/or transmitted by facsimile. The multi-function machine 10 can be a xerographic multi-function machine.

In accordance with the present disclosure, the multi-function machine 10 further includes a document re-ordering subsystem 12 having at least one of software, firmware and hardware for scanning and re-ordering documents and printing the re-ordered documents via the printing assembly 20.

In one embodiment, the document re-ordering subsystem 12 includes a software program having a set of programmable instructions configured for execution by at least one processor 22 of the multi-function machine 10 for scanning and re-ordering documents in a document set. Re-ordering subsystem 12 further includes transmitting the re-ordering results to a remote server 34 or computer 36 operatively connected to the multi-function machine 10 by a data communication network 32 and/or formatting and storing the report on a storage device 30.

The scanning, counting and re-ordering software program can be packaged and distributed as a software package for downloading to the multi-function machine 10 where the set of programmable instructions are stored within at least one computer-readable medium, such as a CD-ROM, diskette, etc. The scanning, counting and re-ordering software program can also be downloaded to the multi-function machine 10 through a network connection connecting the multi-function machine 10 to a remote computer station 36, such as a remote server 34 or terminal 38.

Scanning assembly 18 may be any type of scanning machine. For example, digital document scanners have become a wide-spread tool in many document handling and production tasks. At present, digital scanners for encoding text and images are utilized in office environments both for the storage of documents, the transmission of documents, such as in facsimile machines, and the copying of documents, such as in digital copiers, and so forth. Scanning assembly 18 may include both hand-held devices, sheet-feed devices, and fill page devices. Moreover, full page devices may include automatic sheet-feeding arrangements for drawing a stack of documents to be scanned over a scanning surface in batch processes.

It will be appreciated that the network connections shown are exemplary and other means of establishing a communications link between the computers can be used. The existence of any of various well-known protocols, such as TCP/IP, “ETHERNET”, FTP, HTTP and the like, is presumed, and the system can be operated in a client-server configuration to permit a user to retrieve web pages from a web-based server.

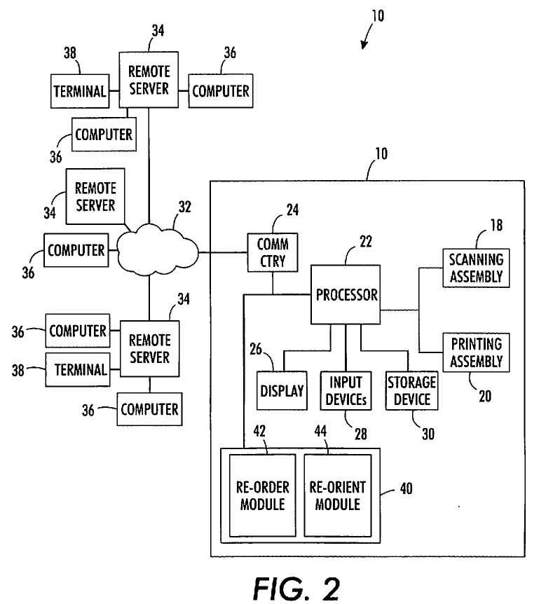

With reference to FIG. 2, there is presented a schematic diagram of a system having a multi-function machine for re-ordering and re-orienting at least one image of a plurality of images of a scanned multi-page document, in accordance with the present disclosure. System 3 is substantially similar to system 1 and thus will only be discussed further herein to the extent necessary to describe differences in the construction and use thereof.

The system 3 includes a multi-function machine 10 having a module interface 40, a re-ordering subsystem 42, a re-orienting subsystem 44, a scanning assembly 18, a printing assembly 20, a processor 22, communication circuitry 24, a display 26, input devices 28 and storage devices 30. The multi-function machine 10 communicates with a communication network 32 that is connected to remote servers 34, computers 36, and terminals 38.

In accordance with the present disclosure, the multi-function machine 10 further includes, in addition to a re-ordering subsystem 42, a document re-orienting subsystem 44 having at least one of software, firmware and hardware for scanning and re-orienting documents and printing the re-oriented documents via the printing assembly 20. The re-ordering subsystem 42 may be grouped together with the re-orienting subsystem 44 as a module interface 40. It is contemplated that the module interface 40 may include a plurality of modules/subsystems for performing a variety of tasks to the one or more scanned documents.

In one embodiment, the document re-orienting subsystem 44 includes a software program having a set of programmable instructions configured for execution by at least one processor 22 of the multi-function machine 10 for scanning and re-orienting documents in a document set. Re-orienting subsystem 44 further includes transmitting the re-orienting results to a remote server 34 or computer 36 operatively connected to the multi-function machine 10 by a data communication network 32 and/or formatting and storing the report on a storage device 30.

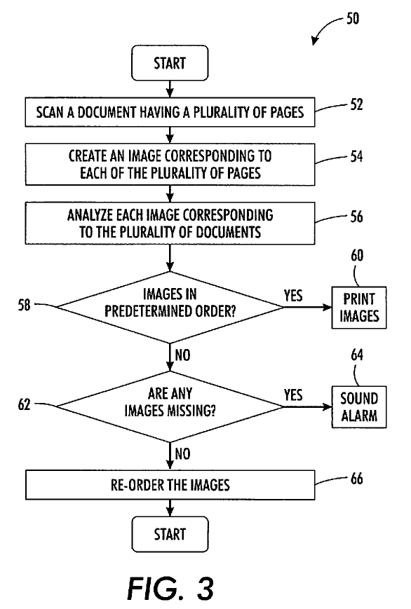

With reference to FIG. 3, there is presented a flowchart of a method for re-ordering and re-orienting at least one image of a plurality of images of a scanned multi-page document, in accordance with the present disclosure.

The flowchart 50 includes the following steps. In step 52, a user scans a document having a plurality of pages. In step 54, an image corresponding to each of the plurality of pages is created. In step 56, each image corresponding to the plurality of documents is analyzed. In step 58 it is determined whether the images are in a predetermined order. If YES, then the process proceeds to step 60 where the images are printer. If NO, then in step 62 it is determined whether any of the images are missing. If YES, then the process proceeds to step 64 where a sound alarm is triggered. If NO, then in step 66 the images are re-ordered. The process then ends.

The technique presented in FIG. 3 permits a user to encode a series of pages, either single-sided or double-sided. Following the scanning process, data representative of the pages is analyzed to verify the order of the scanned pages or to flag missing pages in a batch job. In the case of two-sided documents, the technique facilitates identification of misfeeds of either the recto or verso sides of the documents. The operator may then be notified of a misfeed and re-scan any missing pages.

A similar technique is employed for single-sided documents. The technique permits automatic interleaving of scanned pages of two-sided documents, as well as insertion and re-ordering of pages in both two-sided and single-sided documents. Moreover, the technique may employ character recognition devices, such as optical character recognition, to identify page designations where these are present on one or more of the pages. The locations of the page designations may be automatically determined or may be input by an operator.

Misfeeds and interleaving may proceed based upon the recognized page designations. Where such character recognition techniques are employed, they may be used to verify that sections of batch jobs are presented in a uniform page orientation. The recognition may then prompt reorientation of certain pages in the batch job to provide consistency in the scanned data and page presentation.

Concerning the analyzing step 56, one or more feature attributes are determined for each page in the page sequence. Generally, a feature attribute in the context of the present disclosure is any discernable characteristic resulting from an analysis of a page, the presence or degree of which characteristic may be compared against other similarly analyzed pages.

Additionally, a report may be generated indicating that the scanning operation has been successfully completed. The report may include information regarding possible misfeed or mismatched pages, and the results of character recognition and re-ordering/re-orienting operations. In addition to identifying mismatched pages, the report may also attempt to identify, within each series of pages, which series contains the mismatched page. The scanning, analyzing, re-ordering and re-orienting steps may be further followed by any suitable processing, data transmission, and similar operations, including transmission of facsimiles, printing of hard copies, and so forth.

In summary, the present disclosure proposes an alternative method that takes advantage of “re-ordering and re-orienting” systems relating to printing jobs on MFDs in order to make the process of printing simple and as streamlined as possible to provide for an efficient user experience. The concept of using “re-ordering and re-orienting” systems is a general concept in that it can be used for applications other than printers by any service provider. For example, service providers could use any type of printer and/or MFD and/or electronic device to achieve the desired results of the present disclosure. Also the printing system of the present disclosure makes it easier for information technology (IT) groups and/or service providers to manage/control/operate the printing environment for their clients.

A service provider can be any entity that develops, offers, controls, manages, owns, alters and/or sells software and/or hardware products. A service provider can be any entity that performs one or more tasks on one or more pre-existing MFDs, which may or may not be controlled or owned by the service provider. For example, the entity can offer a service with an existing software package and/or with any type of existing Internet-based service through the Internet. In other words, a service provider need not own or provide the MFDs. The MFDs may be owned or provided by any third party not related or associated with the service provider. In the present disclosure, it is contemplated that the entity (such as a service provider) can offer any type of service and/or product to optimize pre-existing, pre-owned MFDs by referring potential customers to an Internet website or a store that may or may not be associated with printing-related services and/or products. The term “entity” can refer to anything that may exist as a discrete and/or distinct unit that owns, operates, manages, and/or controls one or more of a plurality of machines (such as MFDs). For example, the term “entity” may include the term “company.”

In conclusion, the present disclosure presents a straightforward way of automatically re-organizing, re-ordering, and/or re-orienting a plurality of pages related to one or more documents. The exemplary embodiments of the present disclosure assume that the user may be informed of the scanned jobs re-organized, re-ordered, and/or re-oriented by any type of electronic means (such as by cell phone, by text messaging, by PDA, by PC, etc.)

The present disclosure also includes as an additional embodiment a computer-readable medium which stores programmable instructions configured for being executed by at least one processor for performing the methods described herein according to the present disclosure. The computer-readable medium can include flash memory, CD-ROM, a hard drive, etc.

Embodiments of the present disclosure may be implemented as computer-readable media that include program instructions or program code for performing various computer-implemented operations. The program instructions may be those specially designed and constructed for the purposes of the present disclosure, or they may be of the kind well known and available to those having skill in the computer software arts. Examples of program instructions include, for example, machine code, such as produced by a compiler, and files containing a high-level code that can be executed by the computer using an interpreter.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A multi-function machine having capabilities of scanning and printing documents, the multi-function machine comprising:
a scanning assembly for generating a plurality of electronic images; and
a re-ordering subsystem, operatively associated with the multi-function machine, for performing an ordering determination procedure with respect to the plurality of electronic images, said ordering determination procedure including (1) analyzing the plurality of electronic images to determine whether the plurality of electronic images are in a pre-selected order, and (2) responsive to determining that the plurality of electronic images are not in the pre-selected order, electronically re-ordering at least one of the plurality of electronic images to conform with the pre-selected order.

2. The multi-function machine according to claim 1, wherein the re-ordering subsystem includes a software program having a set of programmable instructions configured for execution by at least one processor for performing the ordering determination procedure and for dispatching an electronic file corresponding to at least one of a printing assembly, a storage device, and a network device.

3. The multi-function machine according to claim 1, wherein the analyzing step further includes performing image processing on at least a particular location of each of said plurality of electronic images by one or more of the following analyzing methodologies: optical character recognition (OCR), plurality of rules, and based on information of an image of the plurality of electronic images.

4. The multi-function machine according to claim 3, wherein the particular location includes for a majority of said plurality of electronic images an item selected from a group consisting of a time, a date, an ordering symbol, an alphanumeric numbering system, a DataGlyph®, and a number, such as a page number and a Bates number.

5. The multi-function machine according to claim 1, further comprising a display for displaying said plurality of electronic images in a pre-ordered thumbnail format and said plurality of electronic images in a post-ordered thumbnail format.

6. The multi-function machine according to claim 1, further comprising a re-orientation subsystem configured for performing an orientation determination procedure including (1) analyzing said plurality of electronic images, (2) determining whether said plurality of electronic images are in a predetermined orientation, and (3) re-orienting at least one image of said plurality of electronic images if it is determined that said at least one image is improperly oriented according to said predetermined orientation.

7. The multi-function machine according to claim 6, wherein at least one of the ordering determination procedure and the orientation determination procedure further comprise means for determining whether an image of said plurality of electronic images is a blank image, and wherein at least one processor provides an audio and/or visual alert indicating that said image is said blank image.

8. The multi-function machine according to claim 1, wherein the ordering determination procedure further comprises determining based on a predetermined order whether at least one image of said plurality of electronic images is missing, and wherein at least one processor provides an audio and/or visual alert indicating that said at least one image of said plurality of electronic images is missing.

9. A method for re-ordering a multi-page document, the method comprising:
generating the multi-page document with a scanning system;
using a processor for:
analyzing the multi-page document to determine whether the pages of the multi-page document conform with a pre-selected order, and
responsive to determining that the multi-page document fails to conform with the pre-selected order, re-ordering one or more pages of the multi-page document so that the multi-page document conforms with the pre-selected order; and
storing said re-ordered multi-page document in memory.

10. The method according to claim 9, wherein the re-ordering subsystem includes a software program having a set of programmable instructions configured for execution by the processor for performing the ordering determination procedure and for dispatching an electronic file corresponding to at least one of a printing assembly, a storage device, and a network device.

11. The method according to claim 9, wherein the analyzing step further includes performing image processing on at least a particular location of each of said plurality of electronic images by one or more of the following analyzing methodologies: optical character recognition (OCR), plurality of rules, and based on information of an image of the plurality of electronic images.

12. The method according to claim 11, wherein the particular location includes for a majority of said plurality of electronic images an item selected from a group consisting of a time, a date, an ordering symbol, an alphanumeric numbering system, a DataGlyph®, and a number, such as a page number and a Bates number.

13. The method according to claim 9, further comprising a display for displaying said plurality of electronic images in a pre-ordered thumbnail format and said plurality of electronic images in a post-ordered thumbnail format.

14. The method according to claim 9, further comprising a re-orientation subsystem configured for performing an orientation determination procedure including (1) analyzing said plurality of electronic images, (2) determining whether said plurality of electronic images are in a predetermined orientation, and (3) re-orienting at least one image of said plurality of electronic images if it is determined that said at least one image is improperly oriented according to said predetermined orientation.

15. The method according to claim 14, wherein at least one of the ordering determination procedure and the orientation determination procedure further comprise means for determining whether an image of said plurality of electronic images is a blank image, and wherein the processor provides an audio and/or visual alert indicating that said image is said blank image.

16. The method according to claim 9, wherein the ordering determination procedure further comprises determining based on a predetermined order whether at least one image of said plurality of electronic images is missing, and wherein the processor provides an audio and/or visual alert indicating that said at least one image of said plurality of electronic images is missing.

17. A system having capabilities of scanning and printing, the system comprising:
a computing device; and
a computer-readable medium in communication with the computing device, the computer readable storage medium comprising one or more programming instructions for:
generating the multi-page document with a scanning system;
analyzing the multi-page document to determine whether the pages of the multi-page document conform with a pre-selected order, and
responsive to determining that the multi-page document fails to conform with the pre-selected order, re-ordering one or more pages of the multi-page document so that the multi-page document conforms with the pre-selected order; and
storing said re-ordered multi-page document in memory.

18. The system according to claim 17, further comprising dispatching an electronic file corresponding to the multi-page document to at least one of a printing assembly, a storage device, and a network device.

19. The system according to claim 17, wherein the analyzing step further includes performing image processing on at least a particular location of each of said plurality of electronic images by one or more of the following analyzing methodologies: optical character recognition (OCR), plurality of rules, and based on information of an image of the plurality of electronic images.

20. The system according to claim 19, wherein the particular location includes for a majority of said plurality of electronic images an item selected from a group consisting of a time, a date, an ordering symbol, an alphanumeric numbering system, a DataGlyph®, and a number, such as a page number and a Bates number.
